(19) United States
(12) Patent Application Publication
(10) Pub. No.: US 2026/0156087 A1
(43) Pub. Date: Jun. 4, 2026

(54) METHOD AND DEVICE WITH ADAPTIVE PATH CONTROL

(71) Applicant: SAMSUNG ELECTRONICS CO., LTD., Suwon-si (KR)

(72) Inventors: Wonseok LEE, Suwon-si (KR); Yong In LEE, Suwon-si (KR); Wonyoung LEE, Suwon-si (KR); Seokbin HONG, Suwon-si (KR)

(73) Assignee: SAMSUNG ELECTRONICS CO., LTD., Suwon-si (KR)

(21) Appl. No.: 19/225,173

(22) Filed: Jun. 2, 2025

(30) Foreign Application Priority Data
Nov. 29, 2024 (KR) 10-2024-0175628

(51) Int. Cl. H04L 49/25; H04L 47/122; H04L 49/00

(52) U.S. Cl. CPC H04L 49/258; H04L 47/122; H04L 49/3009; H04L 49/3018

(57) ABSTRACT

An electronic device including a plurality of groups including a plurality of computing devices and at least one switch connected to one or more of the plurality of computing devices, each switch of the at least one switch including a source switch included in a first group of the plurality of groups, the source switch being connected to a source computing device of the plurality of computing devices for the first group, the source computing device being configured to transmit data to other computing devices for other groups of the plurality of groups and a switching core connected to respective other switches of the other groups of the plurality of groups, the switching core being configured to determine a target path for transmitting the data to a target switch connected to a target computing device of the other computing devices to which the data is to be transmitted.

### CROSS-REFERENCE TO RELATED APPLICATIONS

This application claims the benefit under 35 USC § 119(a) of Korean Patent Application No. 10-2024-0175628, filed on Nov. 29, 2024, in the Korean Intellectual Property Office, the entire disclosure of which is incorporated by reference herein for all purposes.

### BACKGROUND

### 1. Field

The following description relates to a method and device with adaptive path control.

### 2. Description of Related Art

As the size of applications being processed in large-scale computer systems increases, information exchange between processors and/or memory becomes more frequent. However, when the performance of an application is limited by input/output (I/O) bandwidth, securing sufficient bandwidth becomes important.

### SUMMARY

This Summary is provided to introduce a choice of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electronic device including a plurality of groups, each group of the plurality of groups including a plurality of computing devices and at least one switch connected to one or more of the plurality of computing devices, each switch of the at least one switch including a source switch included in a first group of the plurality of groups, the source switch being connected to a source computing device of the plurality of computing devices for the first group, the source computing device being configured to transmit data to other computing devices for other groups of the plurality of groups and a switching core connected to respective other switches of the other groups of the plurality of groups, the switching core being configured to determine a target path for transmitting the data to a target switch connected to a target computing device of the other computing devices to which the data is to be transmitted.

The switching core may be configured to compare a first waiting time for the data to be transmitted via a minimal path with a second waiting time for the data to be transmitted via a second path, the second path being a path other than the minimal path, to determine whether to assign the minimal path as the target path.

The switching core may be configured to determine the first waiting time based on a first number of data packets connected to the target switch, the first number of data packets being queued in a queue buffer of an egress port configured to transmit the data, and a first time required to process a single data packet in the egress port.

In response to the first waiting time being greater than the second waiting time, the switching core may be configured to assign the second path as the target path.

The switching core may be further configured to generate a queue based on a source identification (ID) indicating sources of data packets being queued in queue buffers of egress ports connected to the switching core and determine, based on the queue, the target path in a routing table.

The switching core may be further configured to determine, based on the queue, congestion of data transmission for each of switches connected to the source switch and determine, based on the congestion, the target path in the routing table.

The switching core may be further configured to determine, based on the congestion, the target path by preventing routing to a switch determined to experience congestion.

A size of the queue is 1 less than a number of paths that are 1 hop longer than a minimal path from the source switch to the target switch.

The switching core may be further configured to select the target path from among remaining paths other than a first path that first passes through a switch connected to a computing device corresponding to the source ID included in the queue in the routing table.

Among data packets queued in queue buffers of egress ports connected to the switching core, the switching core may be configured to generate the queue only for a data packet that does not have a computing device connected to the source switch as a source or a target.

In a general aspect, here is provided an electronic device including a plurality of groups, each group of the plurality of groups including a plurality of computing devices and at least one switch connected to one or more of the plurality of computing devices, each switch of the at least one switch including a source switch included in a first group of the plurality of groups, the source switch being connected to a source computing device of the plurality of computing devices for the first group, the source computing device being configured to transmit data to other computing devices for other groups of the plurality of groups, processors configured to execute instructions, and a memory storing the instructions, and an execution of the instructions configures the processors to determine a target path for transmitting the data from the source switch to a target switch connected to a target computing device, the source switch being connected to respective switches included in two or more other groups of the plurality of groups, determine a first waiting time for the data to be transmitted to the target switch included in one of the two or more other groups via a minimal path, compare the first waiting time with a second waiting time for the data to be transmitted to the target switch via a second path, the second path being a path other than the minimal path, assign one of the minimal path and the second path as the target path according to a lesser waiting time among the first waiting time and the second waiting time, and generate a queue based on a source identification (ID) indicating sources of data packets existing on queue buffers of egress ports connected to the source switch.

The processors may be further configured to remove the minimal path from a routing table responsive to the first waiting time being longer than the second waiting time, the routing table including path information for paths among the plurality of groups for transmitting the data from the source switch to the target switch connected to the target computing device.

In a general aspect, here is provided an operation method of an electronic device, the electronic device including a plurality of groups including computing devices and switches connected to one or more of the computing devices, and, in a source computing device of the computing devices for one group of the plurality of groups, a source switch of the source computing device is configured to transmit data to target switches of target computing devices of the computing devices for two or more other groups of the plurality of groups, the method including determining a target path through which the data is transmitted from the source switch to the target switch, determining whether a delay occurs in relation to transmission of the data on a minimal path from the source switch to a target switch of the target switches, and determining a target path for transmitting the data in response to determining that the delay occurs on the minimal path.

The determining of whether the delay occurs may include comparing a first waiting time for the data to be transmitted via the minimal path with other waiting times for the data to be transmitted via paths other than the minimal path.

The determining of whether the delay occurs may include determining the first waiting time based on a number of data packets connected to the target switch and being queued on a queue buffer of an egress port of the source switch and a time required to process a single data packet in the egress port.

The determining of the target path may include assigning a selected path of the other paths as the target path responsive to the first waiting time being greater than the other waiting times.

The determining of the target path may include generating a queue based on a source identification (ID) indicating sources of data packets being queued on queue buffers on egress ports of the source switch and determining, based on the queue, the target path from a routing table.

The determining of the target path may include determining, based on the queue, congestion of data transmission for each of switches connected to the source switch and determining, based on the congestion, the target path from the routing table.

The determining of the target path may include determining, based on the congestion, the target path by preventing routing to a switch determined to experience congestion.

A size of the queue may be 1 less than a number of paths that are 1 hop longer than a minimal path from the source switch to the target switch.

Other features and aspects will be apparent from the following detailed description, the drawings, and the claims.

### BRIEF DESCRIPTION OF THE DRAWINGS

FIGS. 1 and 2 illustrate example electronic devices according to one or more embodiments.

FIG. 3 illustrates an example connection in a computing board and a connection between switches according to one or more embodiments.

FIGS. 4 and 5 illustrate example networks with non-hierarchical topologies having multiple paths according to one or more embodiments.

FIG. 6 illustrates an example routing table according to one or more embodiments.

FIG. 7 illustrates an example target path determination according to one or more embodiments.

FIG. 8 illustrates an example switching apparatus according to one or more embodiments.

FIG. 9 illustrates an example method of operating an electronic device according to one or more embodiments.

FIG. 10 illustrates an example electronic device according to one or more embodiments.

Throughout the drawings and the detailed description, unless otherwise described or provided, it may be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

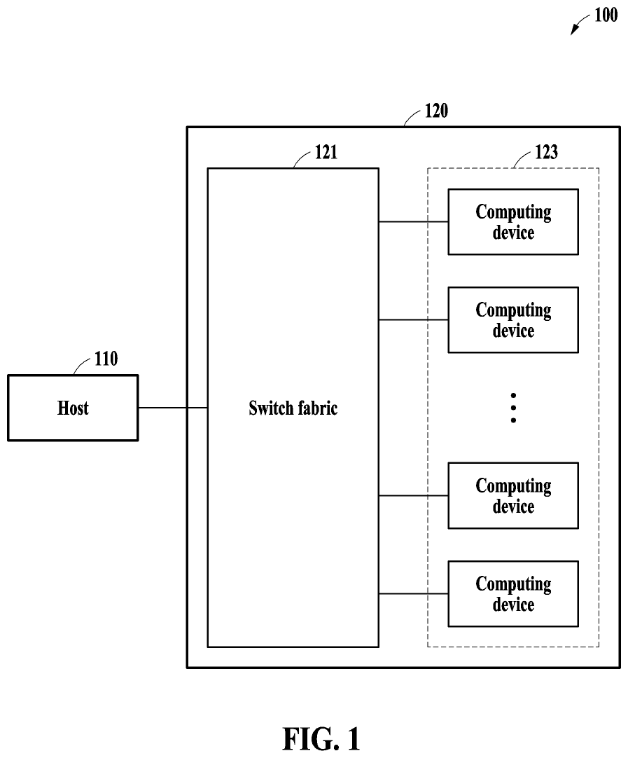

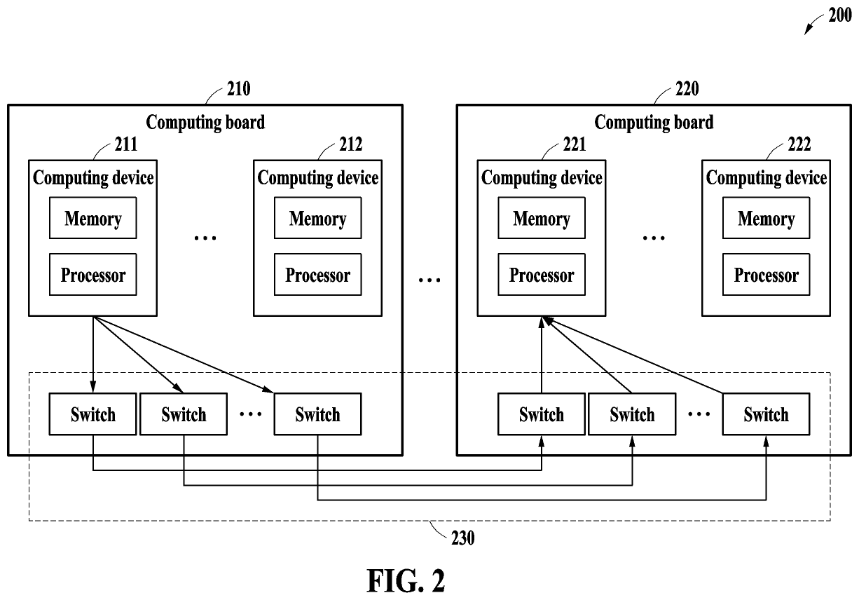

FIGS. 1 and 2 illustrate example electronic devices according to one or more embodiments.

Referring to FIG. 1, in a non-limiting example, an electronic device 100 may include a host 110 and a computing node 120. The host 110 is a device for controlling the computing node 120 and may control, for example, the computing node 120 to transmit data from one of a plurality of computing devices 123 to another one of the plurality of computing devices 123.

The electronic device 100 may be a computing device that connects the plurality of computing devices 123 via a multi-stage electrical interconnection network. For example, the electronic device 100 may include various computing devices such as a high performance computer (HPC), a desktop computer, a workstation, or a server. An electrical interconnection network may be configured, for example, with electrical wiring on a printed circuit board (PCB), making it more cost-effective and simpler compared to an optical interconnection network, which has high power consumption due to electrical-to-optical signal conversion and high costs associated due to optical cables. In an electrical interconnection network, as a signal speed increases to tens of gigahertz (GHz), insertion loss may increase, limiting a possible connection distance. However, this limitation may be addressed through the use of a switch fabric 121 with multiple stages, which is described in greater detail below. The electronic device 100 may support a large-scale computing device pool considering the physical properties of the electrical interconnection network.

The switch fabric 121 may include at least one switch connecting the plurality of computing devices 123. When transmitting data from one of the plurality of computing devices 123 to another one of the plurality of computing devices 123, the switch fabric 121 may divide the data through at least one switch connected via the electrical interconnection network, thereby efficiently maintaining the bandwidth performance between the plurality of computing devices 123.

The at least one switch included in the switch fabric 121 may be grouped into a plurality of groups together with the plurality of computing devices 123 and maximize connections between the computing devices 123 via the multi-stage electrical interconnection network that is divided into an intra-group and an inter-group, thereby expanding the range of a single computing node (e.g., 120). The range of the computing node 120 may be expanded according to a design target required by an application of the electronic device 100.

For ease of description, FIG. 1 illustrates an example in which the electronic device 100 includes one computing node (e.g., 120). However, examples are not limited thereto. The electronic device 100 may also include a plurality of computing nodes. For example, a plurality of computing nodes included in the electronic device 100 may be connected via an optical interconnection network.

In addition, although not illustrated, the electronic device 100 may further include a storage, a disaggregated resource such as non-volatile memory, an optical network, an additional system for management, and a network.

In an example, the electronic device 100 may expand the range of the computing node 120 via an expanded electrical interconnection network in which the at least one switch is connected in the form of fabric, which may effectively maintain bandwidth performance even without using an optical interconnection network that would otherwise require an expensive optical cable.

Referring to FIG. 2, in a non-limiting example, a computing node 200 may include a plurality of computing boards (e.g., a first computing board 210 and a second computing board 220).

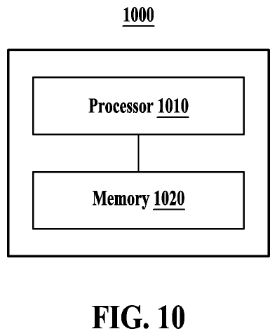

In an example, a plurality of computing devices 211, 212, 221 and 222 (e.g., electronic device 1000 of FIG. 10) and at least one switch included in the computing node 200 may be grouped into a plurality of groups. The respective computing devices and switches grouped into each group may be included in the same computing board. For example, each of the plurality of groups may include the same number of computing devices. In addition, each of the plurality of groups may include the same number of switches.

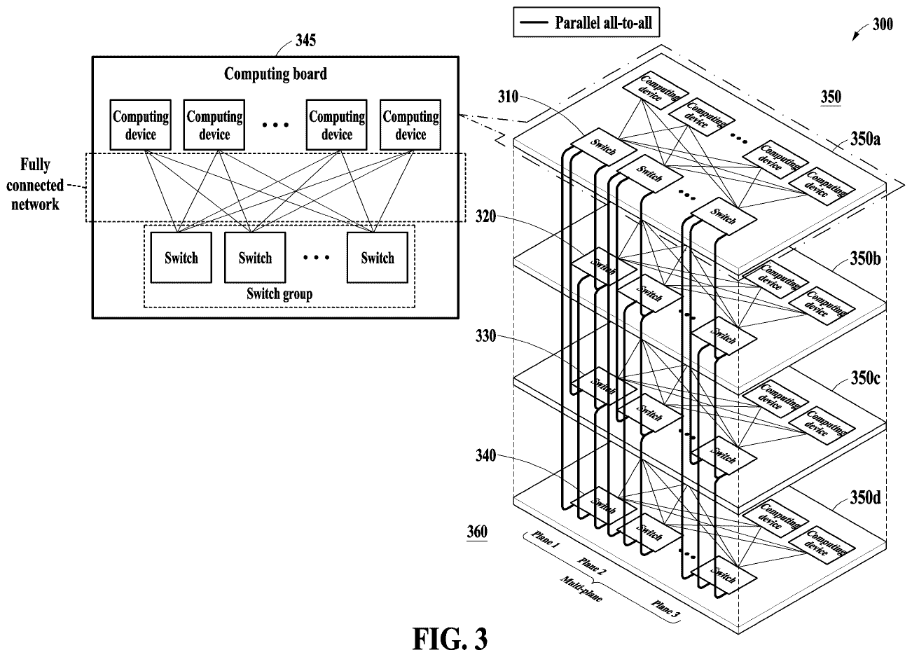

A connection between a computing device and a switch in the same computing board and a connection between switches in different computing boards may be based on an electrical interconnection network. For example, when data is transmitted from a first computing device 211 included in the first computing board 210 to a second computing device 221 included in the second computing board 220, data divided from the first computing device 211 may be transmitted to the second computing device 221 through a switch fabric 230. For example, the first computing device 211 may divide data and transmit the divided data to first switches included in the first computing board 210, the first switches may transmit the divided data to second switches included in the second computing board 220, and the second switches may transmit the divided data to the second computing device 221, so it may be possible to effectively prevent data transmission from being limited by bandwidth. As described in greater detail below with reference to FIG. 3, the first computing device 211 may be connected to all of the first switches included in the first computing board 210, the first switches may be respectively connected to corresponding second switches, and all of the second switches included in the second computing board 220 may be connected to the second computing device 221.

Through the structure of the switch fabric 230, input/output (I/O) bandwidth performance between all of the computing devices in the computing node 200 may be effectively maintained, and the structure of the switch fabric 230 is described in greater detail below with reference to FIG. 3.

FIG. 3 illustrates an example connection in a computing board and a connection between switches according to one or more embodiments.

Referring to FIG. 3, in a non-limited example, a supernode structure 300 for connecting computing boards is illustrated.

In an example, computing devices and switches in the computing board are devices grouped into the same group and may be fully connected to each other (e.g., in a parallel all-to-all manner). Fully connected means that each computing device is electrically connected to all switches within the same group, and each switch is connected to all computing devices within the same group. In this case, each computing device may be connected to the switches with the same bandwidth, and each switch may be connected to the computing devices with the same bandwidth.

In the same group, computing devices in the same group may not be connected to each other and switches may not be connected to each other. In other words, in the same group, one computing device may not be connected to another computing device, and one switch may not be connected to another switch.

As illustrated in FIG. 3, at least one switch in a single computing board may be referred to as a single switch group.

In an example, a plurality of computing boards 350, including computing boards 350a, 350b, 350c, . . . 350n, being represented by computing board 345, may be in the supernode structure 300 with a multi-plane electrical connection structure. The plurality of computing boards 350 may have the supernode structure 300 through switch groups 360, including switches 310, 320, 330, and 340, connected to other computing boards of the plurality of computing boards 350, in a parallel all-to-all manner. For example, in the supernode structure 300, the switch 310, the switch 320, the switch 330, and the switch 340 included in respective computing boards may be connected to each other in a parallel all-to-all manner. In the supernode structure 300, connections between switch groups may be electrical connections between switches in different computing boards.

Each of the switches included in one group may be exclusively connected to one of switches included in other groups. For example, an n-th switch included in one group may be only connected to an n-th switch among switches included in another group and may not be connected to the remaining switches. For example, a first switch included in a first group may be connected to first switches included in second to k groups, respectively, and the first switches respectively included in the first to k groups may be connected to each other with the same bandwidth. Here, n and k may be natural numbers.

However, the above description is provided for the ease of description. The n-th switch included in the first group may not necessarily be connected to the n-th switch included in the second group. An example, in which the n-th switch included in the first group may be connected to one of at least one switch included in the second group and the corresponding switch may not be connected to another switch other than the n-th switch included in the first group, may be applied without limitation.

In an example, in a method of determining a target path in a non-hierarchical topology may include determining a path for transmitting data between switches on the same plane (e.g., Plane 1, Plane 2, and Plane 3). Therefore, herein, for ease of description, in a method of determining a target path transmitting data between switches on the same plane in the supernode structure 300, a computing board (e.g., computing board 345) may be referred to as a board or structure including computing devices and a group including a switch connected to one or more of the computing devices. It should be understood that such a group may include other switches in a switch group and is omitted due to ease of description.

The supernode structure 300 as described above may be a non-hierarchical topology. Switches and components included in the supernode structure 300 may operate at an equal level without a hierarchy.

In the supernode structure 300, there may be a technique for adaptively controlling a path for transmitting data. For example, there may be a technique for selecting a plane in a multi-plane structure and a technique for selecting a minimal path (e.g., a minimal path) or a path (e.g., a non-minimal path) other than the minimal path according to an all-to-all connection structure between computing boards.

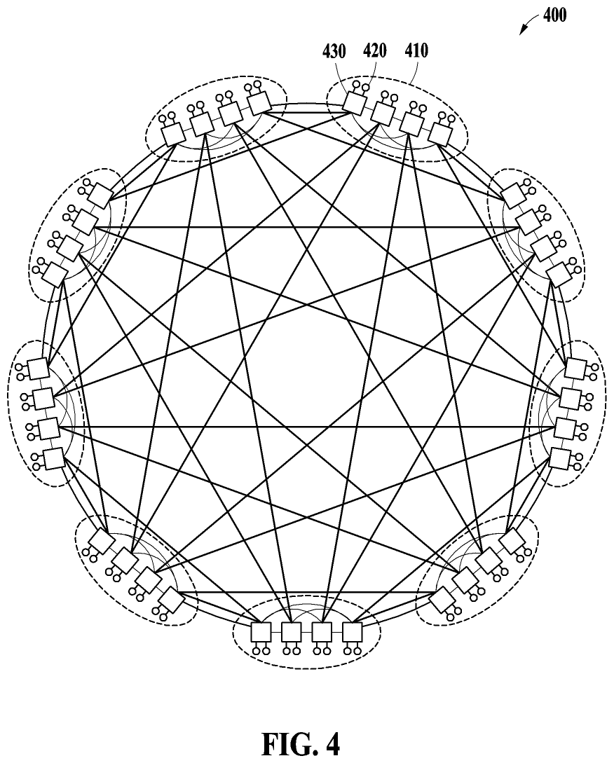

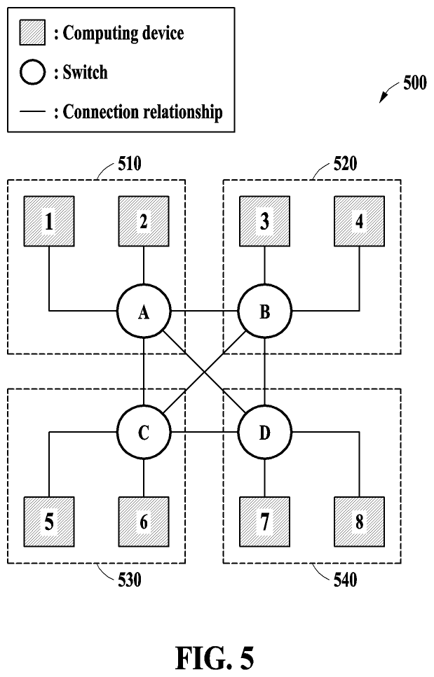

FIGS. 4 and 5 illustrate example networks with non-hierarchical topologies having multiple paths according to one or more embodiments.

Referring to FIG. 4, in a non-limiting example, a dragonfly topology 400, may be arranged in a non-hierarchical topology. The dragonfly topology 400 may include a plurality of groups. For example, the dragonfly topology 400 may include a group 410.

In an example, the group 410 may include at least one switch and a plurality of computing devices. The group 410 may include a switch 430 and a computing device 420. The switch 430 may be connected to one or more of a plurality of computing devices 420. The switch 430 may be connected to a switch in a group other than the group 410 to which the switch 430 belongs in a global link manner. For example, the switch 430 may be connected to switches included in two or more other groups in a global link manner. The switch 430 may be connected to other switches of the group 410 to which the switch 430 belongs in a local link manner.

Referring to FIG. 5, in a non-limiting example, a fabric-shaped topology 500 may include a non-hierarchical topology. The fabric-shaped topology 500 may include a plurality of groups (e.g., a first group 510, a second group 520, a third group 530, and a fourth group 540).

The plurality of groups (e.g., 510, 520, 530, and 540) may include a plurality of computing devices and switches. A switch may be connected to a plurality of computing devices. For example, a switch A may be connected to a computing device 1 and a computing device 2. A switch from each group may be connected to switches from two or more other groups. For example, the switch A may be connected to a switch B, a switch C, and a switch D.

Referring to the supernode structure 300 of FIG. 3, groups included in the same plane and connected to each other in a parallel all-to-all manner may be represented as the fabric-shaped topology 500. For example, the switch A from the first group 510 may correspond to the switch 310 of the supernode structure 300 of FIG. 3, the switch B from the second group 520 may correspond to the switch 320 of the supernode structure 300 of FIG. 3, the switch C from the third group 530 may correspond to the switch 330 of the supernode structure 300 of FIG. 3, and the switch D from the fourth group 540 may correspond to the switch 340 of the supernode structure 300 of FIG. 3.

The supernode structure, the dragonfly topology, and the fabric-shaped topology described above may be networks having non-hierarchical topologies. Herein, for ease of description, a computing device may be designated as one of computing devices presently transmitting data and, in that instance, may be referred to as a source computing device, and a switch through which that data is transmitted, the switch being connected to the source computing device in the same group as the source computing device, may be referred to as a source switch. Herein, for ease of description, a computing device that is intended to receive that data may be referred to as a target computing device, and a switch connected to the target computing device in the same group as the target computing device through which that data may pass may be referred to as a target switch.

The process of determining an optimal path (e.g., a target path) for transmitting data from a source computing device to a target computing device may be referred to as routing. Typical routing, which focuses on improving throughput in a hierarchical topology and considers only congestion of a predetermined port rather than latency that may occur when an alternative path is selected, may not be suitable for a network with a non-hierarchical topology that prioritizes latency performance. For example, when an alternative path is selected to improve throughput, a path that sacrifices latency performance to improve throughput may be selected.

Herein, a routing method suitable for a network having a non-hierarchical topology is described.

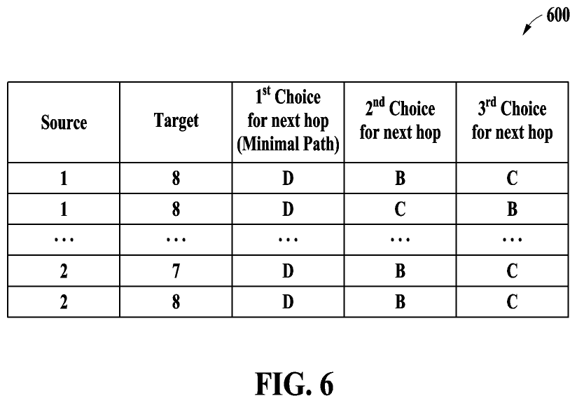

FIG. 6 illustrates an example routing table according to one or more embodiments.

Referring to FIG. 6, in a non-limiting example, a routing table 600 for a fabric-shaped topology (e.g., fabric-shaped topology 500) is illustrated. The routing table 600 may be a data structure used to determine a path through which data is transmitted in a network. The routing table 600 may include path information. The routing table 600 may manage a path from a source to a target on a hop basis. Data may be transmitted on a data packet basis. In FIG. 6, for ease of description, a portion of the routing table 600 is omitted.

The first row of the routing table 600 illustrates a choice of a path when data is transmitted from a computing device 1, which is a source computing device, to a computing device 8, which is a target computing device. A source switch may be a switch A, and a target switch may be a switch D. Referring to the first row of the routing table 600, the shortest distance (i.e., a minimal path), which is a first path, may transmit data directly from the switch A to the switch D, which may be a total of 1 hop. Referring to the first row of the routing table 600, a second path may transmit data from the switch A to the switch D via a switch B, which may be a total of 2 hops. There may be no priority choosing between the switch B or the switch C as the second choice.

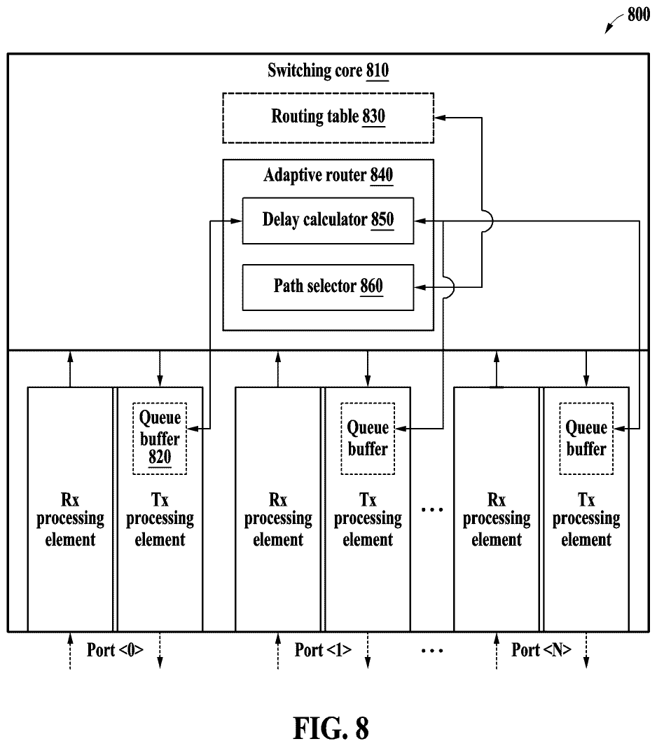

The routing table 600 may be stored in a switching core (e.g., electronic device 1000) of the switch A. The switching core may determine, based on the routing table 600, a target path for transmitting data. The switching core may adaptively determine the target path. For example, the switching core may change the target path while a plurality of data packets that is converted from data is transmitted. For example, the switching core may alter the target path midway through the data transmission such that some of the plurality of data packets are transmitted directly from the switch A to the switch D, while the remaining packets are transmitted from the switch A to the switch D via the switch B. The switching core is described in greater detail below with reference to FIG. 8.

Hereinafter, an example method in which a switch including a switching core alters a target path is described.

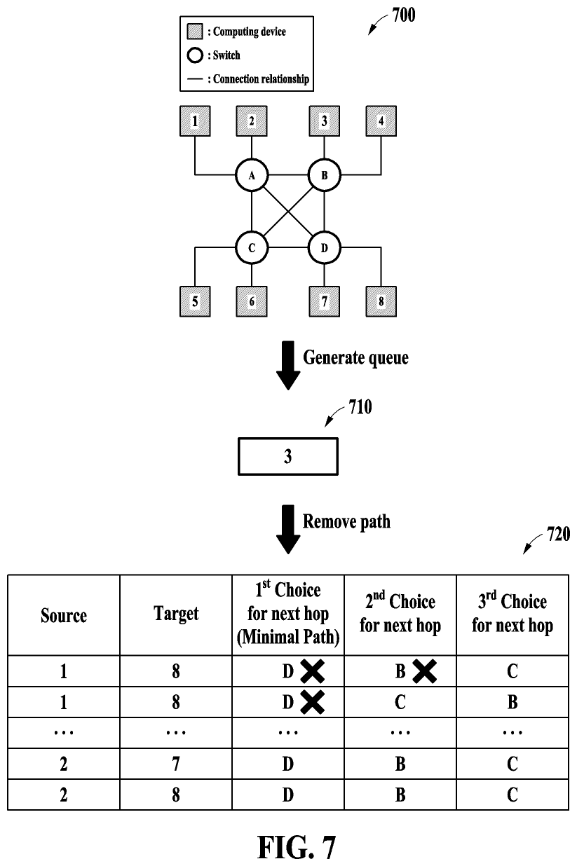

FIG. 7 illustrates an example target path determination according to one or more embodiments.

Herein, for ease of description, a description is provided based on a fabric-shaped topology 700 of FIG. 7. However, the below description may also apply to a network having a non-hierarchical topology.

Referring to FIG. 7, in a non-limiting example, a fabric-shaped topology 700 may be utilized to perform switching using a routing table 720.

In the fabric-shaped topology 700, a source switch may be included in one of a plurality of groups and connected to a source computing device that transmits data. The source switch may be connected to switches included in two or more other groups. A target switch may be included in one of two or more other groups and connected to a target computing device that receives data.

Hereinafter, for ease of description, it is assumed that in the a fabric-shaped topology 700, data is transmitted from a source computing 1 to a target computing 8. Therefore, a switch A may be a source switch and a switch D may be a target switch.

The switch A may receive a data packet converted from data. When receiving the data packet, the switch A may determine whether to transmit a data packet through the shortest distance based on a routing table 700.

In an example, the switch A may check a queue buffer included in an egress port of a port corresponding to the shortest distance among ports included in the switch A. For example, the switch A may check a queue buffer (e.g., queue 710) included in an egress port of a port connected to the switch D. The switch A may measure a time (e.g., T_{S}) required to process a single data packet in an egress port of a port connected to the switch D. The switch A may check the number (e.g., N_{Q}) of data packets existing (i.e., data packets that are queued in) on the queue buffer. The switch A may determine a first waiting time (e.g., Tₑₓₚ) based on the number (N_{Q}) of data packets queued in the queue buffer and the time (T_{S}) required to process a single data packet. For example, the first waiting time (Tₑₓₚ) may be determined by multiplying the number (N_{Q}) of data packets queued in the queue buffer by the time (T_{S}) required to process a single data packet. For example, the first waiting time may be determined as Tₑₓₚ=N_{Q}×T_{S}.

In an example, the switch A may determine a second waiting time (Tₙₒₙ₋ₘᵢₙ), which is a delay time occurring when data is transmitted through a path other than the minimal path. For example, the switch A may determine the second waiting time, which is a delay time occurring when a data packet is transmitted to the switch D via the switch C or the switch B. The second waiting time may be determined as a threshold time. For example, the threshold time may be a time arbitrarily determined by a network administrator. A path other than the minimal path may be a path that is 1 hop longer than the minimal path. The second waiting time may be determined to be n times of the minimum time required when a data packet is transmitted via the minimal path. The second waiting time may be determined to be n times of an average time required when a data packet is transmitted via the minimal path. Here, n may be a natural number greater than or equal to 2.

The switch A may compare the first waiting time with the second waiting time. When the first waiting time is less than or equal to the second waiting time, the switch A may determine the minimal path as the target path for transmitting a data packet. When the first waiting time exceeds the second waiting time, the switch A may determine a path other than the minimal path as the target path. A path other than the minimal path may be a path that is longer than the minimal path. When the first waiting time exceeds the second waiting time, the switch A may remove the minimal path from the routing table 700. For example, the switch A may remove, from the routing table 700, a path to reach the switch D in 1 hop.

Hereinafter, a method of determining, as a target path, a path other than the minimal path is described.

In an example, the switch A may determine, based on the queue 710 showing that a waiting time for the minimal path (i.e., the first waiting time) exceeds a different waiting time for another path (i.e., the second waiting time). Based on this determination, the Switch A may remove the minimal target path from the target path in the routing table 720. That is, there may be other paths remaining in the routing table 720 and these remaining paths, while having a longer pathway to the target computing device, require less waiting time based on their respective queues. With respect to the remaining paths, there may be no priority choosing between the switch C or the switch D as an intermediate switch in the routing table 720 after the minimal path is removed. The switch A may determine, based on the queue 710 indicating congestion of an adjacent switch, a target path in the routing table 720 after the minimal path is removed.

In an example, the switch A may generate the queue 710. The switch A may check sources and targets of data packets queued in queue buffers of egress ports included in the switch A. A source may be the source of a corresponding data packet. For example, a source may be a source computing device, which is the source of a corresponding data packet. A target may be a destination of a corresponding data packet. For example, a target may be a target computing device, which is a destination of a corresponding data packet.

The switch A may generate the queue 710 only for the remaining data packets, that is for data packets other than data packets that already have existing computing devices connected to the switch A as sources or targets among the data packets queued in the queue buffers of the egress ports included in the switch A. This is because, since a data packet that already has the computing devices connected to the switch A as sources may be transmitted to another switch, and a data packet having computing devices connected to the switch A as targets may be transmitted to a computing device connected to the switch A, there may be no longer be any relevance with respect to a congestion for other switches connected to the switch A. Because the remaining data packets described above are transmitted to another switch via the switch A, the remaining data packets may be referred to as intermediate data packets, for ease of description.

In an example, the switch A may generate the queue 710 using intermediate data packets. A queue may include various queues such as a basic queue and a circular queue.

A queue operates in a first-in first-out manner and thus, may be updated whenever an intermediate data packet is transmitted to the switch A.

The size of the queue 710 may be 1 less than the number (e.g., X) of paths that are 1 hop longer than the minimal path from the switch A to the switch D. For example, the size of the queue 710 may be X−1. The minimal path from the switch A to the switch D is 1 hop, and X may represent the number of paths that reach the switch D from the switch A in 2 hops. For example, X may be 2.

The reason for determining the size of the queue 710 to be 1 less than the number of paths that are 1 hop longer than the minimal path from a source switch to a target switch may be to select any one of the remaining switches in a non-hierarchical topology, excluding source and target switches. For example, the size of the queue 710 generated by the switch A may be 2. When the size of the queue 710 is 2 and the queue 710 includes the source ID of a computing device connected to the switch B and the source ID of a computing device connected to the switch C, it may be impossible to select a target path.

Therefore, the size of the queue 710 is set to 1 (e.g., a single queue), meaning the queue 710 may store information about only one intermediate data packet sequentially input to the switch A. This information may be updated as intermediate data packets are input to the switch A on a first-in, first-out basis.

The switch A may store only the source (e.g., source ID) of the intermediate data packet in the queue 710. The source ID may represent identification information for a computing device, which is the source of the intermediate data packet.

The switch A may determine, based on the queue 710 generated using the aforementioned method, a target path in the routing table 720 from which the minimal path is removed. The intermediate data packet being transmitted to the queue 710 may be due to congestion occurring at a switch directly connected to a computing device corresponding to the source ID of the intermediate data packet. Since the intermediate data packet of the switch A does not have computing devices connected to the switch A as either sources or targets, the intermediate data may be transmitted to the switch A to avoid congestion.

The switch A may determine, based on the queue 710, the congestion of data transmission for each switch connected to the switch A. The switch A may determine, based on the congestion, the target path in the routing table 720.

For example, the switch A may determine, based on the source ID (e.g., 3) included in the queue 710, that congestion occurs at the switch B connected to a computing device 3. The switch A may remove a path that transmits data to the switch D via the switch B from a routing table 720. Based on the routing table 720 with the path through which data is transmitted to the switch D via the switch B being removed, the switch A may determine, as the target path, a path that transmits the data to the switch D via the switch C.

When there are priorities among paths or switches in the routing table 720, the switch A may determine the target path based on the priorities in the routing table 720. The switch A may also randomly select a path based on the routing table 720 with paths removed and determine the selected path as the target path.

Hereinafter, a switch that performs the operations described above is described.

FIG. 8 illustrates an example switching apparatus according to one or more embodiments.

Referring to FIG. 8, in a non-limiting example, a switch 800 may include a switching core 810 and a plurality of ports.

Each of the plurality of ports may be connected to a switch or a computing device. For example, the switch A of FIG. 7 may include 5 ports, where 2 ports are connected to computing devices, and 3 ports may be connected to switches.

Each of the plurality of ports may include an ingress port (e.g., reception (Rx) processing element of FIG. 8) and an egress port (e.g., transmission (Tx) processing element of FIG. 8). The plurality of ports may receive data through the ingress port and transmit data through the egress port.

The egress port may include a queue buffer 820. The queue buffer 820 may temporarily store data packets that are transmitted through the egress port. The data packets stored in the queue buffer 820 may be transmitted sequentially.

In an example, the switch 800 may include a switching core 810. The switching core 810 may determine the destination of data and perform switching between ports. The switching core 810 may efficiently process a data packet received by the switch 800 and determine a target path for transmitting the data packet. The switching core 810 may include a routing table 830. The switching core 810 may determine the target path based on the routing table 830.

The switching core 810 may include an adaptive router 840. The adaptive router 840 may remove a path from the routing table 830 based on an analysis of a queue and a state of congestion of the minimal path. That is, the switching core may decide that a waiting time for the minimal path (i.e., the first waiting time) to remove the minimal path from the routing table 830.

In an example, the adaptive router 840 may include a delay calculator 850. The delay calculator 850 may determine a first waiting time that occurs when data is transmitted via a minimal path from the switch 800 to a target switch included in one of two or more other groups connected to the switch 800.

The delay calculator 850 may include first circuitry for measuring the time required to process a single data packet in a queue buffer of a port connected to the target switch. The delay calculator 850 may include second circuitry for checking the number of data packets queued in a queue buffer of a port connected to the target switch. The delay calculator 850 may include a multiplier for calculating the first waiting time by multiplying the values obtained from the first circuit and the second circuit, as well as a memory for storing the first waiting time, the value from the first circuit, and the value from the second circuit.

In an example, the adaptive router 840 may include a path selector 860. The path selector 860 may compare the first waiting time with the second waiting time, which occurs when data is transmitted through a non-minimal path, determine that a delay occurs when the first waiting time is longer than the second waiting time, and remove a path from the routing table 830 by generating a queue based on source IDs indicating sources of the data packets queued in queue buffers of egress ports connected to the switching core 810.

The adaptive router 840 may include a comparison operator for comparing the first waiting time with the second waiting time. The adaptive router 840 may include a memory for storing a queue. The adaptive router 840 may include a processing element configured to remove a path from the routing table 830 based on the queue.

In an example, the switching core 810 may be an electrical device (e.g., electrical device 1000) including processing elements (e.g., processor 1010) configured to determine the destination of data and perform switching between ports. In addition, the adaptive router 840 may likewise be an electrical device (e.g., electrical device 1000) including processing elements (e.g., processor 1010) to perform calculating delays (e.g., delay calculator 850) and path selection (e.g., path selector 860).

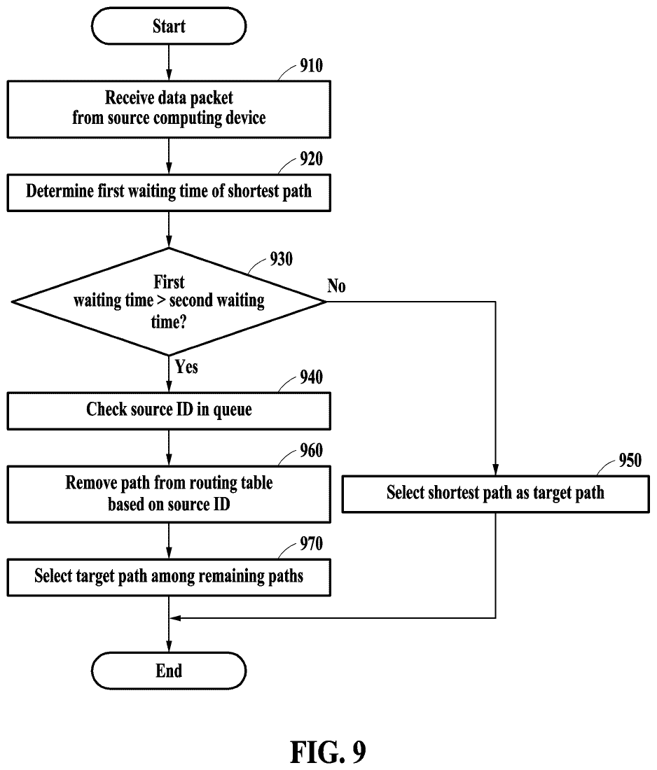

FIG. 9 illustrates an example method of operating an electronic device according to one or more embodiments.

In the following examples, operations may be performed sequentially but not necessarily. For example, the order of the operations may be changed, and at least two of the operations may be performed in parallel. Operations 910 to 970 may be performed by components of the electronic device having a non-hierarchical topology network.

Referring to FIG. 9, in a non-limiting example, in operation 910, an electronic device (e.g., electronic device 1000) with a source switch may (e.g., switch 310) receive a data packet from a source computing device (e.g., computing device 211).

In an example, in operation 920, the electronic device (e.g., electronic device 1000) with the source switch (e.g., switch 310) may determine a first waiting time of a minimal path.

The electronic device may determine the first waiting time (Tₑₓₚ) based on the number (N_{Q}) of data packets queued in a queue buffer of an egress port connected to a target switch and transmitting data and a time (T_{S}) required to process a single data packet in the egress port.

In an example, in operation 930, the electronic device (e.g., electronic device 1000) with the source switch (e.g., switch 310) may determine whether the first waiting time exceeds a second waiting time.

The electronic device may determine whether a delay occurs in relation to transmission of data along a minimal path to the target switch. When the first waiting time is longer than the second waiting time, it may be determined that the delay occurs on the minimal path.

The second waiting time may be a waiting time when data is transmitted via a path other than the minimal path. However, this is only an example, and examples are not limited thereto. For example, the second waiting time may be a threshold time set by a network administrator.

In an example, the electronic device (e.g., electronic device 1000) with the source switch (e.g., switch 310) may perform operation 940 when the first waiting time exceeds the second waiting time. The electronic device may perform operation 950 when the first waiting time does not exceed the second waiting time.

In an example, in operation 950, the electronic device (e.g., electronic device 1000) with the source switch (e.g., switch 310) may determine the minimal path as a target path.

In addition, in operation 940, the electronic device may check a source ID in a queue.

The electronic device may check the source ID stored in the queue. The electronic device may generate a queue. The electronic device may generate a queue based on a source ID indicating sources of data packets queued in queue buffers of egress ports connected to a switching core. The electronic device may generate a queue only for a data packet (e.g., an intermediate data packet) that does not have a computing device connected to the electronic device as a source or a target among data packets queued in the queue buffers of the egress ports connected to the switching core.

The size of a queue may be 1 less than the number of paths that are 1 hop longer than the minimal path from the electronic device to the target switch.

In an example, in operation 960, the electronic device (e.g., electronic device 1000) with the source switch (e.g., switch 310) may remove a path from a routing table based on a source ID.

The electronic device may remove a path from the routing table based on a queue.

The electronic device may determine, based on the queue, congestion of data transmission for each switch connected to the electronic device and remove, based on the congestion, a path from the routing table based on the detected congestion. The electronic device may prevent, based on the congestion, routing to a switch determined to experience congestion.

In an example, in operation 970, the electronic device (e.g., electronic device 1000) with the source switch (e.g., switch 310) may select a target path among the remaining paths.

The electronic device may select the target path based on the routing table from which a path is removed according to operations 910 to 940 and 960. The electronic device may select one of the remaining paths included in the routing table from which a path is removed and determine the selected path as the target path. The electronic device may determine the target path based on priorities on the routing table among the remaining paths included in the routing table from which a path is removed.

Since operations 910 to 970 are described in detail with reference to FIGS. 1 to 8, the detailed description thereof is omitted.

FIG. 10 illustrates an example electronic device according to one or more embodiments.

Referring to FIG. 10, in a non-limiting example, an electronic device 1000 may control a superconducting quantum circuit system, and the electronic device 1000 may include a processor 1010 and a memory 1020. In an example, the processor 1010 may be or control a host (e.g., host 110) and/or computing node (e.g., computing node 120). The electronic device 1000 may be or make up the electronic device 100 and/or its computing devices 123.

The processor 1010 may be one or more processors or processing elements. The processor 1010 may be configured to execute programs or applications to configure the processor 1010 to control the electronic apparatus 1000 to perform one or more or all operations and/or methods involving the control of switching paths with adaptive control, and may include any one or a combination of two or more of, for example, an xPU such as a central processing unit (CPU), a graphics processing unit (GPU), a neural processing unit (NPU), and a tensor processing unit (TPU), but is not limited to the above-described examples.

The memory 1020 may include computer-readable instructions. The processor 1010 may be configured to execute computer-readable instructions, such as those stored in the memory 1020, and through execution of the computer-readable instructions, the processor 1010 is configured to perform one or more, or any combination, of the operations and/or methods described herein. The memory 1010 may be, for example, a high-bandwidth memory. The processor is a device for performing an operation and may be, for example,.

The electronic devices, processors, memories, switches, computing devices, computing boards, electronic device 100, host 110, computing node 120, switch fabric 121, computing devices 123, computing node 200, first computing board 210, second computing board 220, computing devices 211, 212, 221 and 222, switch fabric 230, supernode structure 300, computing boards 345, plurality of computing boards 350, switch groups 360, switches 310, 320, 330, and 340, dragonfly topology 400, group 410, computing device 420, switch 430, fabric-shaped topology 500, groups 510, 520, 530, and 540, fabric-shaped topology 700, switch 800, switching core 810, queue buffer 820, adaptive router 840, delay calculator 850, electronic device 1000, processor 1010, and memory 1020 described herein and disclosed herein described with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
a plurality of groups, each group of the plurality of groups comprising:
a plurality of computing devices; and
at least one switch connected to one or more of the plurality of computing devices,
wherein each switch of the at least one switch comprises:
a source switch comprised in a first group of the plurality of groups, the source switch being connected to a source computing device of the plurality of computing devices for the first group, the source computing device being configured to transmit data to other computing devices for other groups of the plurality of groups; and
a switching core connected to respective other switches of the other groups of the plurality of groups, the switching core being configured to determine a target path for transmitting the data to a target switch connected to a target computing device of the other computing devices to which the data is to be transmitted.

2. The electronic device of claim 1, wherein the switching core is configured to compare a first waiting time for the data to be transmitted via a minimal path with a second waiting time for the data to be transmitted via a second path, the second path being a path other than the minimal path, to determine whether to assign the minimal path as the target path.

3. The electronic device of claim 2, wherein the switching core is configured to determine the first waiting time based on a first number of data packets connected to the target switch, the first number of data packets being queued in a queue buffer of an egress port configured to transmit the data, and a first time required to process a single data packet in the egress port.

4. The electronic device of claim 2, wherein, in response to the first waiting time being greater than the second waiting time, the switching core is configured to assign the second path as the target path.

5. The electronic device of claim 1, wherein the switching core is further configured to:
generate a queue based on a source identification (ID) indicating sources of data packets being queued in queue buffers of egress ports connected to the switching core; and
determine, based on the queue, the target path in a routing table.

6. The electronic device of claim 5, wherein the switching core is further configured to:
determine, based on the queue, congestion of data transmission for each of switches connected to the source switch and determine, based on the congestion, the target path in the routing table.

7. The electronic device of claim 6, wherein the switching core is further configured to:
determine, based on the congestion, the target path by preventing routing to a switch determined to experience congestion.

8. The electronic device of claim 5, wherein a size of the queue is 1 less than a number of paths that are 1 hop longer than a minimal path from the source switch to the target switch.

9. The electronic device of claim 5, wherein the switching core is further configured to:
select the target path from among remaining paths other than a first path that first passes through a switch connected to a computing device corresponding to the source ID comprised in the queue in the routing table.

10. The electronic device of claim 5, wherein, among data packets queued in queue buffers of egress ports connected to the switching core, the switching core is configured to generate the queue only for a data packet that does not have a computing device connected to the source switch as a source or a target.

11. An electronic device, comprising:
a plurality of groups, each group of the plurality of groups comprising:
a plurality of computing devices; and
at least one switch connected to one or more of the plurality of computing devices,
wherein each switch of the at least one switch comprises:
a source switch comprised in a first group of the plurality of groups, the source switch being connected to a source computing device of the plurality of computing devices for the first group, the source computing device being configured to transmit data to other computing devices for other groups of the plurality of groups;
processors configured to execute instructions; and
a memory storing the instructions, wherein execution of the instructions configures the processors to:
determine a target path for transmitting the data from the source switch to a target switch connected to a target computing device, wherein the source switch is connected to respective switches comprised in two or more other groups of the plurality of groups;
determine a first waiting time for the data to be transmitted to the target switch comprised in one of the two or more other groups via a minimal path;
compare the first waiting time with a second waiting time for the data to be transmitted to the target switch via a second path, the second path being a path other than the minimal path;
assign one of the minimal path and the second path as the target path according to a lesser waiting time among the first waiting time and the second waiting time; and
generate a queue based on a source identification (ID) indicating sources of data packets existing on queue buffers of egress ports connected to the source switch.

12. The device of claim 11, wherein the processors are further configured to:
remove the minimal path from a routing table responsive to the first waiting time being longer than the second waiting time, the routing table including path information for paths among the plurality of groups for transmitting the data from the source switch to the target switch connected to the target computing device.

13. An operation method of an electronic device, wherein the electronic device comprises a plurality of groups including computing devices and switches connected to one or more of the computing devices,
wherein, in a source computing device of the computing devices for one group of the plurality of groups, a source switch of the source computing device is configured to transmit data to target switches of target computing devices of the computing devices for two or more other groups of the plurality of groups, and
wherein the method comprises:
determining a target path through which the data is transmitted from the source switch to the target switch;
determining whether a delay occurs in relation to transmission of the data on a minimal path from the source switch to a target switch of the target switches; and
determining a target path for transmitting the data in response to determining that the delay occurs on the minimal path.

14. The operation method of claim 13, wherein the determining of whether the delay occurs comprises:
comparing a first waiting time for the data to be transmitted via the minimal path with other waiting times for the data to be transmitted via paths other than the minimal path.

15. The operation method of claim 14, wherein the determining of whether the delay occurs comprises:
determining the first waiting time based on a number of data packets connected to the target switch and being queued on a queue buffer of an egress port of the source switch and a time required to process a single data packet in the egress port.

16. The operation method of claim 14, wherein the determining of the target path comprises:
assigning a selected path of the other paths as the target path responsive to the first waiting time being greater than the other waiting times.

17. The operation method of claim 13, wherein the determining of the target path comprises:
generating a queue based on a source identification (ID) indicating sources of data packets being queued on queue buffers on egress ports of the source switch; and
determining, based on the queue, the target path from a routing table.

18. The operation method of claim 17, wherein the determining of the target path comprises:
determining, based on the queue, congestion of data transmission for each of switches connected to the source switch; and
determining, based on the congestion, the target path from the routing table.

19. The operation method of claim 18, wherein the determining of the target path comprises:
determining, based on the congestion, the target path by preventing routing to a switch determined to experience congestion.

20. The operation method of claim 17, wherein a size of the queue is 1 less than a number of paths that are 1 hop longer than a minimal path from the source switch to the target switch.
